(19) United States
(12) Patent Application Publication
(10) Pub. No.: US 2021/0016460 A1
(43) Pub. Date: Jan. 21, 2021

(54) MALE PUBIC HAIR TRIMMING DEVICE

(71) Applicant: Kevin A. SONDEREGGER, Lake St. Louis, MO (US)

(72) Inventor: Kevin A. SONDEREGGER, Lake St. Louis, MO (US)

(21) Appl. No.: 16/659,827

(22) Filed: Oct. 22, 2019

Related U.S. Application Data
(60) Provisional application No. 62/875,762, filed on Jul. 18, 2019.

(51) Int. Cl. B26B 21/52

(52) U.S. Cl. CPC B26B 21/527; B26B 21/522

(57) ABSTRACT

A grooming device of a male pubic hair trimming device operates in a sensitive area that needs stretching of skin. The device has a spherical surface forming a body, a first aperture through the surface, a second aperture through the surface and opposite the first aperture, a chamber communicating from the first aperture to the second aperture, an edge condition for each aperture at the surface, and the first aperture being coaxial with the second aperture. The device has a flexible construction that permits partial compression by a user's fingers, if desired, and antifungal, medical grade construction for durability. By using the device, a man slides the round, solid device onto his finger, or thumb, and stretches the skin of his pubic area to easily and confidently apply his razor for a smooth and close shave.

### CROSS-REFERENCE TO RELATED APPLICATION

This non-provisional application claims priority to the pending provisional application 62/875,762 filed on Jul. 18, 2019 and all of which have a common inventor.

### BACKGROUND OF THE INVENTION

The present invention relates generally to grooming devices, and more particularly to a male pubic hair trimming device that allows a user to readily stretch his skin and hair on it for trimming.

Millennia ago, man lived on the land and off of the land. Man dressed himself in loincloths and other garments made from animals he caught. Man dressed the animals, skinned them, and prepared their hides into leather for garments. Man clothed himself in these rough garments for millennia and adapted them to various parts of the world. Woman, living in the same conditions as man, also wore hides and both man and woman fussed little about their personal body appearances.

Centuries then passed and man developed agriculture, growing various crops. From those crops, and livestock who ate them, man developed thread which led to cloth and that became more comfortable garments for man and woman. Man and woman could don such garments readily, and also doff them. Man began making clothing from cotton, grasses, flax, wool, and other materials. Nearly simultaneously with garment improvements, man developed fragrances. Fragrances deployed as colognes, washes, spritzes, and rinses masked many odors and postponed bathing for months at a time. Woman took notice of man looking better in improved garments and with a pleasant fragrance. Man and woman would doff clothing from time to time as they are wont to do.

Following the plagues of Europe and more particularly the advent of indoor plumbing, man began to bathe regularly. In some countries, man bathes daily or more frequently. Timely bathing has improved hygiene and wellbeing for man and woman. Woman has noticed man more clean and better smelling these modern days. Woman would see man exiting the bath or the shower and see more of him, and be mostly pleased. Man and woman would also doff clothing, and woman would be mostly pleased.

Man has shaved his face for centuries. Perhaps other areas call for a shave. In recent years, woman, seeing more of man than ever before, sought a bit more grooming from man: a smooth pubic region. Such smoothness heightens attraction and sex between man and woman, and woman is pleased with man. But shaving the pubic region gives man great pause.

Man takes great pride in his pubic region and the thought of sharp objects near there sends a shudder through man. The pubic area has great renown as problematic for men to shave. Shaving the pubic area has the moniker of manscaping these days. Though manscaping grows in popularity, existing technology has few devices that address stretching of the pubic area skin to ease shaving of it.

A man typically applies his razor to a region of skin, such as the cheek, and moves it along the skin and against the hairs, thus cutting the hairs. As a man shaves, he twists and turns his bones and muscles of his face to achieve the smoothest, or taut, surface for obtaining a consistent and smooth shave. A man readily does this upon his cheeks by moving his jaw and upon his neckline by lifting his head.

Ah though, the male anatomy of the testicles presents a more complicated and sensitive region. According to external temperature, internal temperature, blood pressure, fear, anxiety, medical conditions, and the like, the skin upon the testicles, or scrotum, retracts or lengthens making that region a challenge to shave. Additionally, the merging of the base of the shaft of the penis to the scrotum produces a region that slopes inwardly and raises the difficulty and risk to move a razor against it.

Hearing man express these difficulties, woman still encouraged man to improve his grooming just a bit more and shave the pubic region. Man thus had renewed inspiration.

### DESCRIPTION OF THE PRIOR ART

Turning about 14, boys learn to shave their faces from their fathers, brothers, cousins, uncles, coaches and others. Turning into a man, his shaving continues through his lifetime. A man becomes quite good at shaving his own face. Shaving other body parts calls for more patience and skill. Sometimes man has those, many times not.

Industry has developed disposable razors and razors of wide description and increasing blade counts. Such razors usually have a handle grasped in one of man's hands and man uses the other hand for other tasks. The razors generally present a flat, elongated blade to the surface of man's cheek and man draws the handle perpendicular to the angle of the blades. Many a man has drawn the handle parallel to the length of the blades and lacerated himself. Man usually does that once and learns. Drawing a handled razor in the pubic region has increased risk of lacerating skin, or worse, in that region. Therefore, a need exists for a man to create a taut firm surface of his scrotum to use a razor and groom that part of him successfully. Woman looks forward to developments in this line of technology.

### SUMMARY OF THE INVENTION

The present invention of a male pubic hair trimming device has a spherical surface upon a body, a first aperture through the surface, a second aperture through the surface and opposite the first aperture, a chamber communicating from the first aperture to the second aperture, an edge condition for each aperture at the surface, and the first aperture being coaxial with the second aperture. The device has a flexible construction that permits partial crushing, or compressing, by a user's fingers, if desired.

The present invention provides a male pubic hair trimming device that allows a man to stretch his scrotum, the region of the testicles, and create a taut, firm surface suitable for application of a razor. The device has a generally rounded form with a centered aperture. The aperture allows the device to fit upon the tip of a finger or slide further down the finger. The rounded surface of the device gently permits a man to move his testicles within the scrotum around its natural curves and around the surface of the invention thus stretching the scrotum over the surface of the device. The device allows a man to further move the device in various positions upon his body so he may groom other parts of his pubic region. Returning to the aperture, it has a position into the device that allows a man to slide the device upon his finger. The man uses the other four fingers of that hand to stretch his scrotum upon the device while he applies his razor using his dominant hand. The aperture also has a size for a tip of a man's finger so he may utilize the device at the base of his penis and stretch his scrotum and testicles over the device. This stretches the skin region, perineum, between the legs and the underside of his scrotum.

There has thus been outlined, rather broadly, the more important features of the invention in order that the detailed description thereof that follows may be better understood and that the present contribution to the art may be better appreciated. The device has medical grade construction, anti-fungal material, select sizes, and additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a male pubic hair trimming device that creates a firm surface, or taut scrotum, so a man may apply a razor carefully to his testicles.

Another object is to provide such a male pubic hair trimming device that a man may use with one hand.

Another object is to provide such a male pubic hair trimming device that a lightly grasps the scrotum thus minimizing abrasion and other injuries to that tissue.

Another object is to provide such a male pubic hair trimming device that has durability.

Another object is to provide such a male pubic hair trimming device that cleans readily using no more than residential dishwasher cleansing.

Another object is to provide such a male pubic hair trimming device that stores readily for continuous use.

Another object is to provide such a male pubic hair trimming device that accommodates various sizes of man and his anatomy.

Another object is to provide such a male pubic hair trimming device that receives a multitude of colors, indicia, and patterns for a wide variety of customization.

Another object is to provide such a male pubic hair trimming device that may be easily and efficiently manufactured and marketed to the consuming public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is a perspective view of the present invention;

FIG. 2 is a side view of the invention;

FIG. 3 is a top view of the invention;

FIG. 4 is a side view of the invention opposite from FIG. 2; and,

FIG. 5 is a bottom view of the invention.

The same reference numerals refer to the same parts throughout the various figures.

### DESCRIPTION OF THE PREFERRED EMBODIMENT

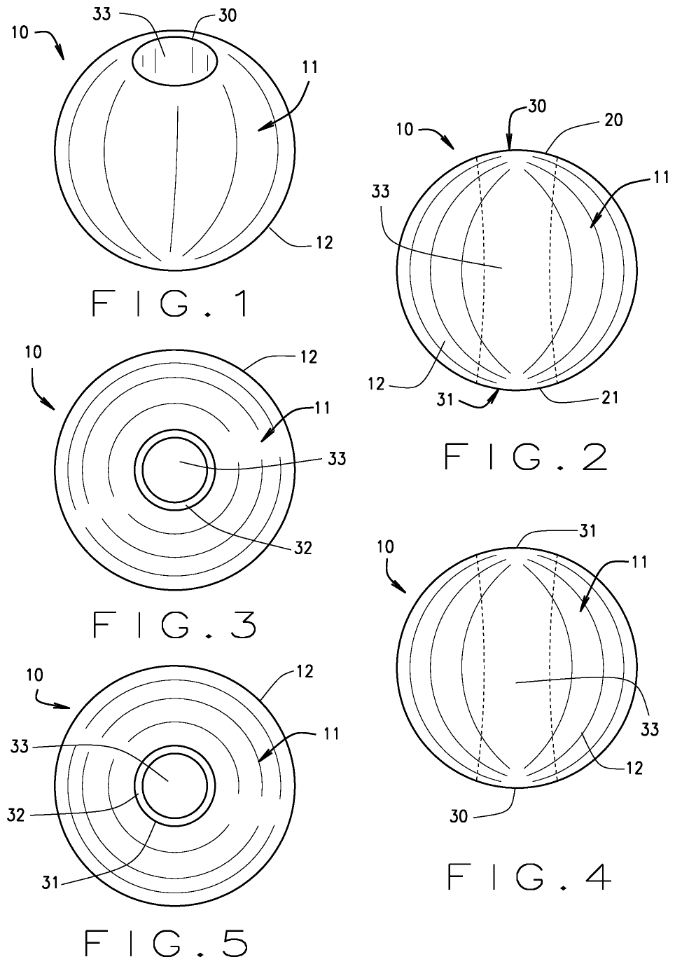

The present invention overcomes the prior art limitations by providing a male pubic hair trimming device. The device accounts for the sensitivity, curvature, and risk of shaving that area of a man. Turning to FIG. 1, the male pubic hair trimming device 10 of the present invention appears in a perspective view. The present invention has a spherical body 12 with a surface 11. The spherical body has a constant diameter through a central point interiorly of the surface. The surface extends over most of the invention except for a first end 20 and an opposite second end 21, not shown, having an open first aperture 30 and an open second aperture 31, not shown, respectively. The surface does not extend over the apertures 30, 31, that is, incompletely, while the apertures do permit a man to insert a finger or a thumb into them during usage of the invention. The apertures 30, 31 interrupt the surface and the surface does not extend over the apertures, that is, the body lacks surface over the apertures.

Turning to FIG. 2, the invention appears in a side view with the first end 20 oriented upwardly in the figure and the second end 21 shown downwardly in the figure. The first end and the second end are mutually parallel and spaced apart as shown. The first aperture also appears coaxial with the second aperture. In an alternate embodiment, the first end and the second end each denote a flat plane appearing when a chordal portion of a sphere does not form. The alternate embodiment has the first end 20 of a greater width, that is, chord length, then the second end 21. Rotating the invention, FIG. 3 shows a top view of it with the first end 20 in the foreground. The first end has the first aperture 30 shown in the center of the figure. The first aperture extends into the invention and communicates through the second aperture. The device 10 has its surface 11 of spherical form as before and the surface has a transition ring, as at 32, or edge condition, between it and the first aperture 30. The transition ring eases the insertion of a user's finger or thumb into the first aperture for user comfort. The transition ring may have a square edge between the surface and the first aperture, a beveled edge, a rounded edge, or the like.

More particularly, this figure illustrates the proportion between the first aperture, the second aperture, and the diameter of the invention. The invention generally has an approximately 30 mm to an approximately 60 mm diameter, with an approximately 45 mm preferred. A typical human finger has a diameter ranging from about 14 mm to about 25 mm. Thus, the invention has a diameter ranging from double to triple the diameter of a human finger, or alternatively expressed as a finger being one third to one half of the diameter of the device. The first aperture and the second aperture are round in shape and thus the first aperture has its diameter and the second aperture also has its diameter. The first aperture communicates to the second aperture through a chamber 33. The chamber extends through the body. The chamber has a generally hollow, round, cylindrical form of about 22 mm, and thus its own diameter. The Applicant foresees a diameter of the chamber from about 8% to about 50% of the diameter of the invention. The chamber has its own length slightly less than the diameter of the device as placement of the chamber removes material from the surface to provide the first aperture and the second aperture into the chamber. In an alternate embodiment, the diameters of the first aperture and the second aperture are the same. In an alternate embodiment, the diameters of the first aperture and the chamber are the same.

In an alternate embodiment, the first aperture has an edge condition as at 32 proximate to the surface. The edge condition may have the form of square, beveled, rounded, curved, arcuate, and the like. The edge condition transitions the surface into the chamber through the first aperture for user comfort. The invention has a symmetric form and thus the second aperture may also have an edge condition.

FIG. 4 is a side view of the invention opposite that of FIG. 2. Because the invention has symmetry, this figure matches that of FIG. 2. The symmetry allows a user to grip the invention at any rotational angle measured perpendicular to the axis of the chamber. That is, a user may rotate the device when placed upon his finger, as needed.

FIG. 5 then shows a bottom view of the invention with the second aperture 31 present in the foreground. The second aperture has its edge condition, as at 32, as that of the first aperture, proximate the surface. The second aperture communicates through the chamber 33 to the first aperture in the background of this figure. In an alternate embodiment, the invention is symmetric.

From the aforementioned description, a male pubic hair trimming device has been described. The male pubic hair trimming device is uniquely capable of placement upon a user's finger then rotation upon that finger allowing a user to place and to stretch tissue upon the device. Further, the male pubic hair trimming device may also have an edge condition comfortable to a user's finger when inserted into the device, an alternate asymmetric form with the first end of a different diameter than the second end, hypoallergenic construction, and other related features compatible with the structure and purpose of the invention as shown and described. The male pubic hair trimming device and its various components may be manufactured from many materials, including but not limited to, polymers, such as nylon, polypropylene, polyvinyl chloride, high density polyethylene, and composites.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like -when they appear- are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A grooming device, comprising:
a spherical body having a surface;
a first aperture into said body and a second aperture into said body opposite said first aperture; and,
a chamber providing communication from said first aperture to said second aperture.

2. The grooming device of claim 1, further comprising:
said first aperture interrupting said surface and said second aperture interrupting said surface wherein said surface incompletely extends over said body.

3. The grooming device of claim 2 wherein said first aperture is coaxial with said second aperture.

4. The grooming device of claim 3 wherein said first aperture has a diameter and said second aperture has a diameter.

5. The grooming device of claim 4 wherein the diameter of said first aperture is the same as the diameter of said second aperture.

6. The grooming device of claim 5 wherein said chamber has a diameter the same as the diameter of said first aperture.

7. The grooming device of claim 3 further comprising:
an edge condition around said first aperture proximate said surface and an edge condition around said second aperture proximate said surface;
wherein said edge condition provides for comfort of the user.

8. The grooming device of claim 3 wherein said grooming device is symmetric.

9. A grooming device suitable for a user to grasp and to stretch pubic tissue and organs thereon for shaving, said grooming device comprising:
a surface having a constant diameter upon a central point, said surface defining a spherical body;
said surface having a first aperture therein and entering into said body, and a second aperture therein opposite said first aperture and entering into said body; and,
said first aperture communicating to said second aperture through a chamber in said body.

10. The grooming device of claim 9 further comprising:
said first aperture being coaxial with said second aperture;
said device having a flexible construction compressible by a user; and,
said device being symmetric.

11. The grooming device of claim 10 further comprising:
said first aperture having a diameter and said second aperture having a diameter.

12. The grooming device of claim 11 further comprising:
the diameter of said first aperture being the same as the diameter of said second aperture.

13. The grooming device of claim 11 further comprising:
said chamber having a diameter the same as the diameter of said first aperture.

14. The grooming device of claim 11 further comprising:
said first aperture interrupting said surface and said second aperture interrupting said surface wherein said surface incompletely extends over said body.

15. The grooming device of claim 13 further comprising:
the diameter of said chamber ranging from about 8% to about 50% of the diameter of said device.

16. A grooming device suitable for a user to grasp and to stretch pubic tissue and organs thereon for shaving, said grooming device comprising:
a spherical body having a surface, a first aperture into said body and a second aperture into said body opposite said first aperture, and a chamber providing communication from said first aperture to said second aperture;
said first aperture interrupting said surface and said second aperture interrupting said surface, said surface incompletely extending over said body;
said first aperture being coaxial with said second aperture; and,
said first aperture having a diameter and said second aperture having a diameter.

17. The grooming device of claim 16 further comprising:
said chamber having a diameter the same as the diameter of said first aperture;
the diameter of said chamber ranging from about 8% to about 50% of the diameter of said device; and,
said first aperture having an edge condition proximate said surface, said edge condition being one of square, beveled, rounded, curved, and arcuate.

18. The grooming device of claim 16 further comprising:
said first aperture being coaxial with said second aperture;
the diameter of said first aperture being the same as the diameter of said second aperture;
said device being symmetric; and,
said device having a flexible construction compressible by a user.

19. The grooming device of claim 16 wherein said body lacks said surface over said first aperture and said second aperture.

20. The grooming device of claim 16 further comprising:
said chamber having a diameter the same as the diameter of said first aperture;
the diameter of said chamber ranging from about 8% to about 50% of the diameter of said device;
said first aperture being coaxial with said second aperture;
the diameter of said first aperture being the same as the diameter of said second aperture, and said device being symmetric; and,
said first aperture interrupting said surface and said second aperture interrupting said surface wherein said surface incompletely extends over said body.
